(19) United States
(12) Patent Application Publication
(10) Pub. No.: US 2015/0191940 A1
(43) Pub. Date: Jul. 9, 2015

(54) MULTI-FUNCTIONAL LOCK

(71) Applicants: An-Jan Chen, Changhua (TW); Yung- Hsun Chen, Changhua (TW)

(72) Inventors: An-Jan Chen, Changhua (TW); Yung- Hsun Chen, Changhua (TW)

(21) Appl. No.: 14/274,740

(22) Filed: May 11, 2014

(30) Foreign Application Priority Data
Jan. 8, 2014 (TW) 103200362

(51) Int. Cl. E05B 67/00

(52) U.S. Cl. CPC E05B 67/00

(57) ABSTRACT

A multi-functional lock may include a main body, a control unit, a connecting unit and a securing unit. The multi-functional lock is advantageous because the main body uses the connecting unit to control the securing unit and control unit, and a rod and a locking unit are independent components, so when the user is conducting a forcefully unlocking process, only the rod is damaged without damaging the main body and the rod can be easily replaced.

### FIELD OF THE INVENTION

This invention relates to a lock, and more particularly to a multi-functional lock.

### BACKGROUND OF THE INVENTION

Conventionally, as shown in FIGS. 9 and 10, a lock may include a lock case 50, a lock securing equipment 60 and a lock bar 70. The lock case 50 contains an insert hole 51 and a cut opening 52. A keyhole 53 and a perforation 54 are connected through the lock case 50 paralleled to each other. The perforation 54 is to pass through the cut opening 52. The lock securing equipment 60 is installed inside the lock case 50, and a key (not shown in the figure) can be inserted into the keyhole 51. When the lock securing equipment 60 is performing an unlock action, a lock plug 61 is located at the keyhole 53 of the lock securing equipment 60, and a securing plug 62 is disposed close to the cut opening 52. A resilient piece 63 is disposed between the lock plug 61 and the securing plug 62, so the lock securing equipment 60 can control the movement of lock plug 61, securing plug 62, and resilient piece 63. The lock bar 70 has a short bar 71 and long bar 72, and the short bar 71 is inserted into the keyhole 53 of the lock case 50, while the long bar 72 is inserted inside the perforation 54. The lock bar 70 close to lock plug 61 has a gap 73, and a limiting slot 74 is disposed close to the securing plug 62, and a shrinking segment 75 is formed corresponding to the resilient piece 63. With a general locking situation, the securing plug 62 is inserted in the limiting slot 74, and the lock bar 70 cannot be unlocked. If forcefully unlocking the device, the lock bar 70 can be cut-off from cut opening 52, so the short bar 71 can be released from keyhole 53 to unlock the device successfully. When the short bar 71 from lock bar 70 is pushed back into keyhole 53 inside the lock case 50, the lock plug 61 may be stopped at the gap 73, and the device will be temperately locked. If a user wants to restore to the original unlock status, the lock securing equipment 60 has to be unlocked, so the resilient piece 63 can be released from the shrinking segment 75 of the lock bar 70 to fully extract the lock bar 70, and an undamaged lock bar 70 can be disposed onto the lock itself.

However, the conventional lock has the following disadvantages: (1) in the situation that may need to forcefully unlock the lock itself, the lock bar 70 has to be damaged, and it has to be be removed and replaced. Also, during the replacement, the lock 70 has to be inserted into the keyhole 53 and perforation 54 in the lock case 50, as well as avoiding the lock securing equipment 60 and the securing plug 62, which causes the replacement difficult and inconvenient and the costs thereof may increase; and (2) the lock bar 70 can only be unlocked through short bar 71, not the long bar 72, which may cause some inconvenience as well. Therefore, there remains a need for a new and improved lock to overcome the problems stated above.

### SUMMARY OF THE INVENTION

The present invention provides a dual-functional lock may include a main body, a control unit, a connecting unit and a securing unit. The main body has a first position and a second position. One side of the main body has a cipher lock that has a locking unit at the first position, and a pressing hole is located at the second position. A conjugating unit is located between the pressing hole and the cipher lock. The cipher lock has a locking rod connecting with a swing block close to the locking unit. A receiving space is formed on the other side of the cipher lock and has a through hole communicating with the first position. One side of the receiving space has a vertical trough, and a first horizontal trough, a second horizontal trough and a third horizontal trough are formed between the vertical trough and the receiving space, and the third horizontal trough is closest to the conjugating unit. The vertical trough has a through opening communicating with the second position and a cut opening is formed at the through opening, so a rod can pass the through opening and expose at the cut opening. A fixed unit is formed closed to the second position and the fixed unit can be disposed against the rod due to the resilience of the fixed unit to control the rod, so the rod can only be pulled out from the cut opening. A covering board is used to cover the main body and the main body has an aperture and a short groove at the first position, and the short groove is communicating with the through hole. The locking unit is a long and elastic rod and a ball is formed on both ends of the locking unit, and the ball can be inserted into the main body through the aperture and the through hole. The swing block and the control unit can be used to lock the ball. The control unit is located at the receiving space of the main body and the control unit has an evading space near the through hole, and an elongated board is located at one end of the control unit. The elongated board has a first notch and a second notch, and a spring is located at one side of the elongated board. The connecting unit is at the vertical trough of the main body, and a connecting spring is disposed at one end of the rod. The connecting unit also has an upper trough, a lower trough and a stopping block. The upper trough and the lower trough are formed along opposite directions and the upper trough, lower trough and stopping block are located at back side of the control unit. The securing unit has a first latch, a second latch and a restricting block. The first latch is inside the first horizontal trough and has a protruding block corresponding to the upper trough and a securing spring is disposed on top of the protruding block. A protruding piece corresponding to the lower trough is disposed at the second horizontal trough, and a spring is disposed at the top of the protruding piece. A inclined surface is formed on one end of the conjugating unit, a stopping portion is protrudingly formed on the other end of the restricting block, and a second spring is disposed at the same end of the stopping portion.

In a further embodiment, the exercise equipment for pace training may further include a connecting belt. Both ends of the connecting belt have a connector that has a connecting piece with a reverse hook, and a plugging hole is formed on both sides near the connecting portion of the extension rod and the plugging hole has a conjugating point that is connecting and communicating therewith. The connector is configured to plug into the plugging hole of the extension rod while the connecting piece is engaging with the conjugating point with the reverse hook, so the connecting belt can be connected between two parallel extension rods to enhance the structural strength of the connection of the extension rod and the connecting unit. Furthermore, the space between two parallel extension rods can be adjusted through the connecting belt.

According to the abovementioned embodiments, the present invention is advantageous because (1) the main body uses the connecting unit to control the securing unit and control unit, and the rod and the locking unit are independent components, so when the user is conducting a forcefully unlocking process, only the rod is damaged without damaging the main body and the rod can be easily replaced; (2) the locking unit is placed inside of the main body through hole and aperture with the ball. Also, the ball is restricted by a short groove and aperture to lock the main body, and user can unlock from either the cipher lock or the control unit.

### BRIEF DESCRIPTION OF THE DRAWINGS

FIG. 1 illustrates a three-dimensional view of the present invention.

FIG. 2 illustrates a three-dimensional exploded view of the present invention.

FIG. 3 illustrates an exploded view of the control unit and securing unit of the present invention.

FIG. 4 illustrates a sectional view of the present invention.

FIG. 5 illustrates a first schematic view of the present invention when in use.

FIG. 6 illustrates a second schematic view of the present invention when in use.

FIG. 7 illustrates a third schematic view of the present invention when in use.

FIG. 8 illustrates a fourth schematic view of the present invention when in use.

FIG. 9 illustrates a first three-dimensional view of the prior art.

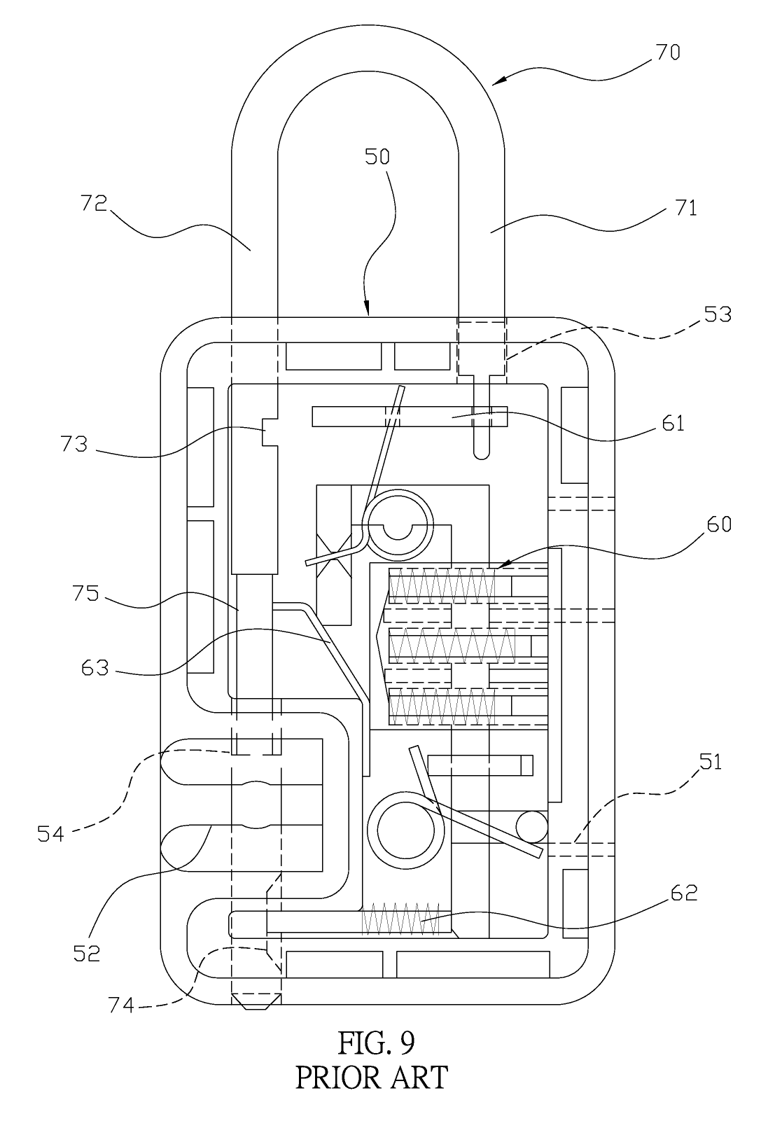

FIG. 10 illustrates a second three-dimensional view of the prior art.

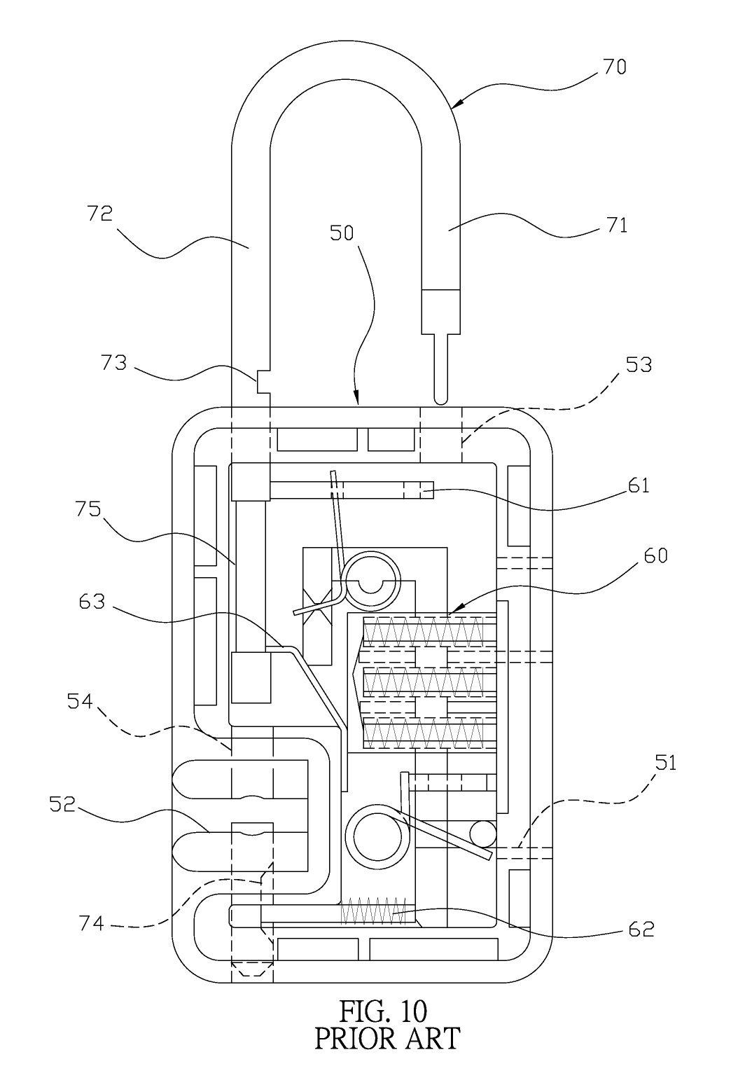

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

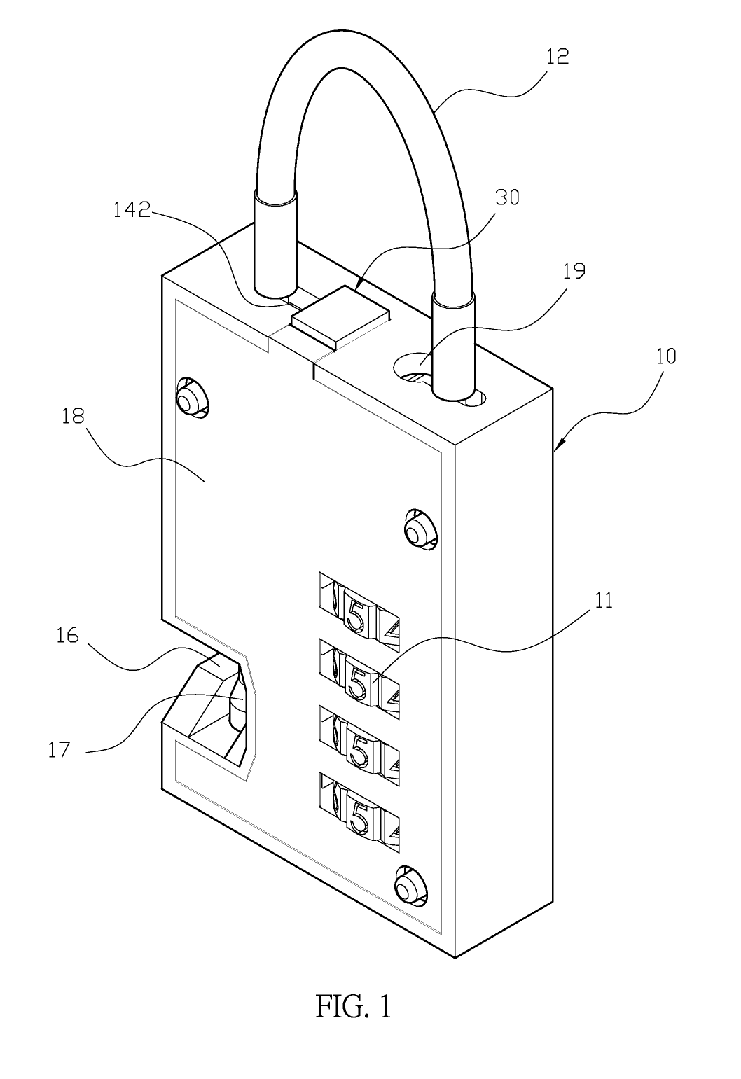

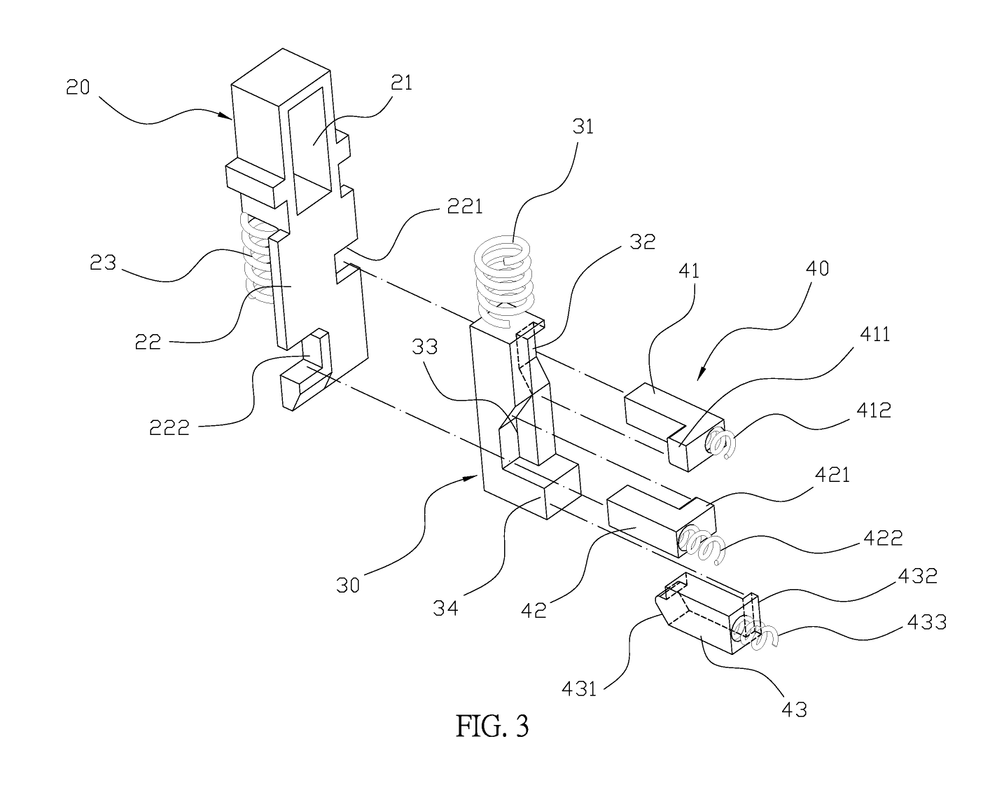

Referring to FIGS. 1 to 3, a dual-functional lock may include a main body 10, a control unit 20, a connecting unit 30 and a securing unit 40. The main body 10 has a first position 101 and a second position 102. One side of the main body 10 has a cipher lock 11 that has a locking unit 12 at the first position 101, and a pressing hole 111 is located at the second position 102. A conjugating unit 13 is located between the pressing hole 111 and the cipher lock 11. The cipher lock 11 has a locking rod 112 connecting with a swing block 113 close to the locking unit 12. A receiving space 14 is formed on the other side of the cipher lock 11 and has a through hole 141 communicating with the first position 101. One side of the receiving space 14 has a vertical trough 15, and a first horizontal trough 151, a second horizontal trough 152 and a third horizontal trough 153 are formed between the vertical trough 15 and the receiving space 14, and the third horizontal trough 153 is closest to the conjugating unit 13. The vertical trough 15 has a through opening 154 communicating with the second position 102 and a cut opening 16 is formed at the through opening 154, so a rod 17 can pass the through opening 154 and expose at the cut opening 16. A fixed unit 161 is formed closed to the second position 102 and the fixed unit 161 can be disposed against the rod 17 due to the resilience of the fixed unit 161 to control the rod 17, so the rod 17 can only be pulled out from the cut opening 16. A covering board 18 is used to cover the main body 10 and the main body 10 has an aperture 19 and a short groove 142 at the first position 101, and the short groove 142 is communicating with the through hole 141. The locking unit 12 is a long and elastic rod and a ball 121 is formed on both ends of the locking unit 12, and the ball 121 can be inserted into the main body 10 through the aperture 19 and the through hole 141. The swing block 113 and the control unit 20 can be used to lock the ball 121. The control unit 20 is located at the receiving space 14 of the main body 10 and the control unit 20 has an evading space 21 near the through hole 141, and an elongated board 22 is located at one end of the control unit 20. The elongated board 22 has a first notch 221 and a second notch 222, and a spring 23 is located at one side of the elongated board 22. The connecting unit 30 is at the vertical trough 15 of the main body 10, and a connecting spring 31 is disposed at one end of the rod 17. The connecting unit 30 also has an upper trough 32, a lower trough 33 and a stopping block 34. The upper trough 32 and the lower trough 33 are formed along opposite directions and the upper trough 32, lower trough 33 and stopping block 34 are located at back side of the control unit 20. The securing unit 40 has a first latch 41, a second latch 42 and a restricting block 43. The first latch 41 is inside the first horizontal trough 151 and has a protruding block 411 corresponding to the upper trough 32 and a securing spring 412 is disposed on top of the protruding block 411. A protruding piece 421 corresponding to the lower trough 33 is disposed at the second horizontal trough 152, and a spring 422 is disposed at the top of the protruding piece 421. A inclined surface 431 is formed on one end of the conjugating unit 13, a stopping portion 432 is protrudingly formed on the other end of the restricting block 43, and a second spring 433 is disposed at the same end of the stopping portion 432.

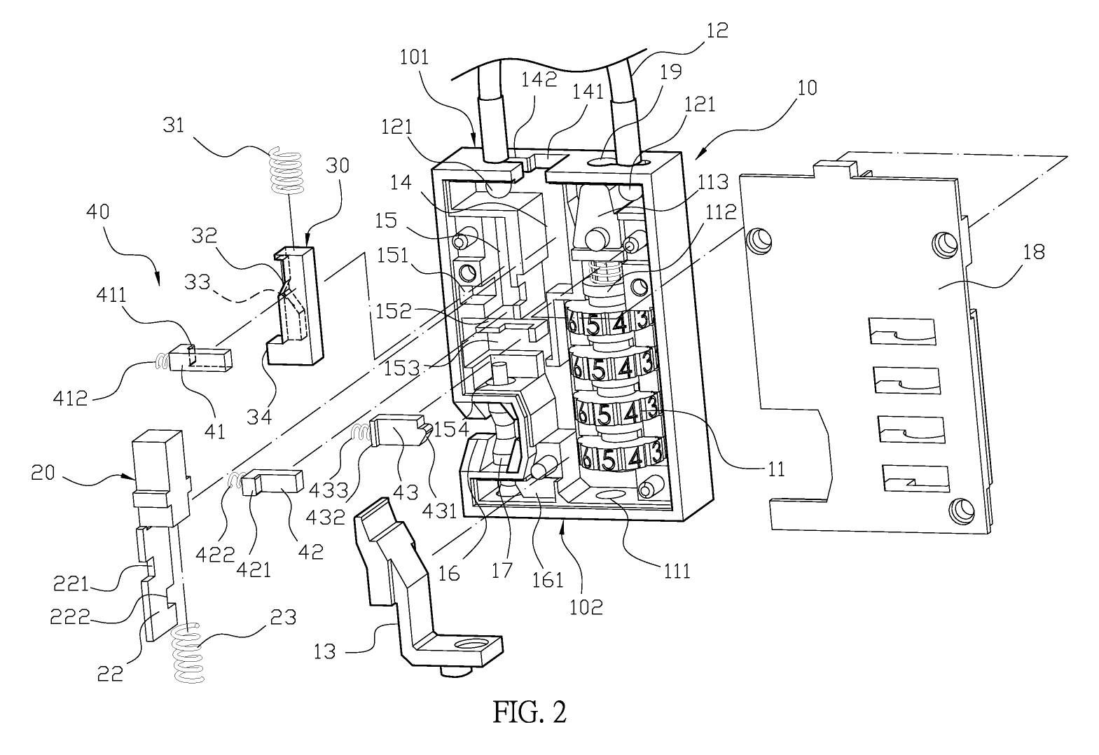

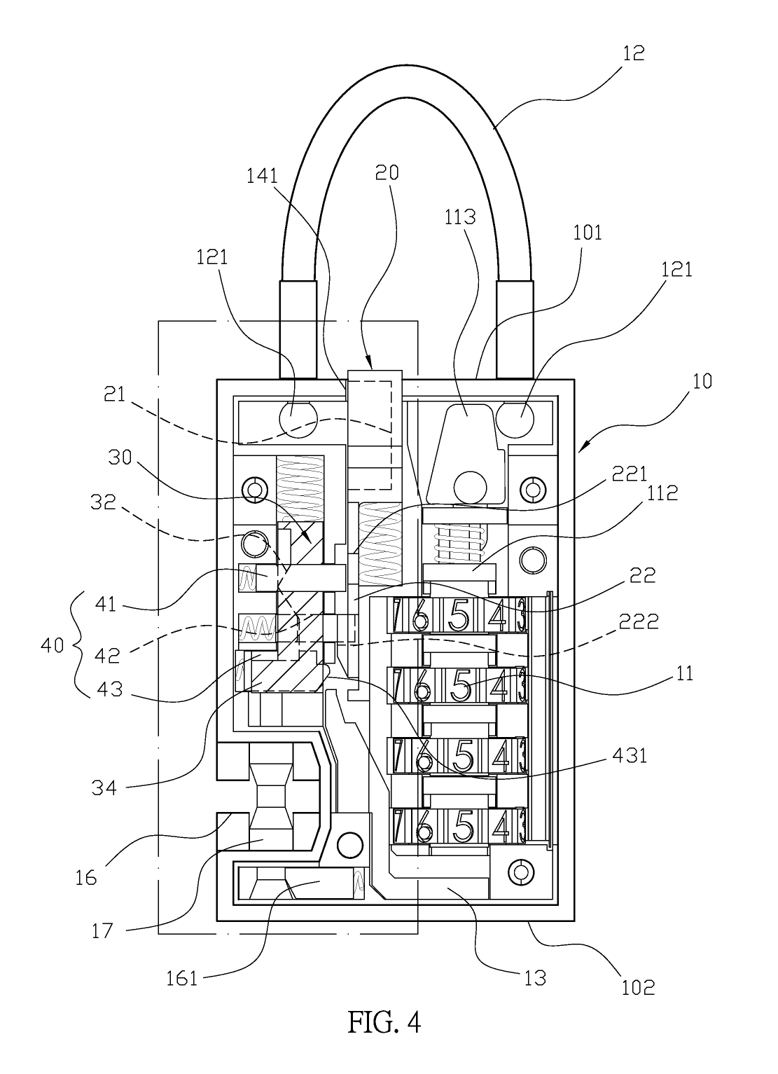

Referring to FIGS. 2 to 4, the locking unit 12 is placed inside of the main body 10 through hole 141 and aperture 19 with the ball 121. Also, the ball 121 is restricted by a short groove 142 and aperture 19. The cipher lock 11 is located at one side of the main body 10, and the swing block 113 is used to restrict the ball 121. The conjugating unit 13 is disposed at the second location 102 of the main body 10 and the rod 17 is plugged into the through opening 154 of the main body 10. The control unit 20 is disposed at the receiving space 14 of the main body 10, and the through hole 141 is formed at one end of the control unit 20 with the evading space 21, and the other end is pushed by the spring 23. The securing unit 40 is placed inside of the second horizontal trough 152 with the second latch 42 to enable the spring 422 to be pushed toward the direction of the elongated board 22. Also, the restricting block 43 is disposed inside of the third horizontal trough 153, and the inclined surface 431 of the restricting block 43 is also pushed towards the direction of cipher lock 11. The connecting unit 30 is disposed at the vertical trough 15, so the protruding portion 421 of the second plug 42 is corresponding to the lower trough 33 of the connecting unit 30. Furthermore, the first latch 41 of the securing unit 40 is disposed in the first horizontal trough 151 to enable the securing spring 412 to push the first latch 41 toward the elongated board 22. Meanwhile, the protruding block 411 is disposed at the upper trough 32 of the connecting unit 30 and finally the covering board 18 is secured on the main body 10 to finish the assembly process.

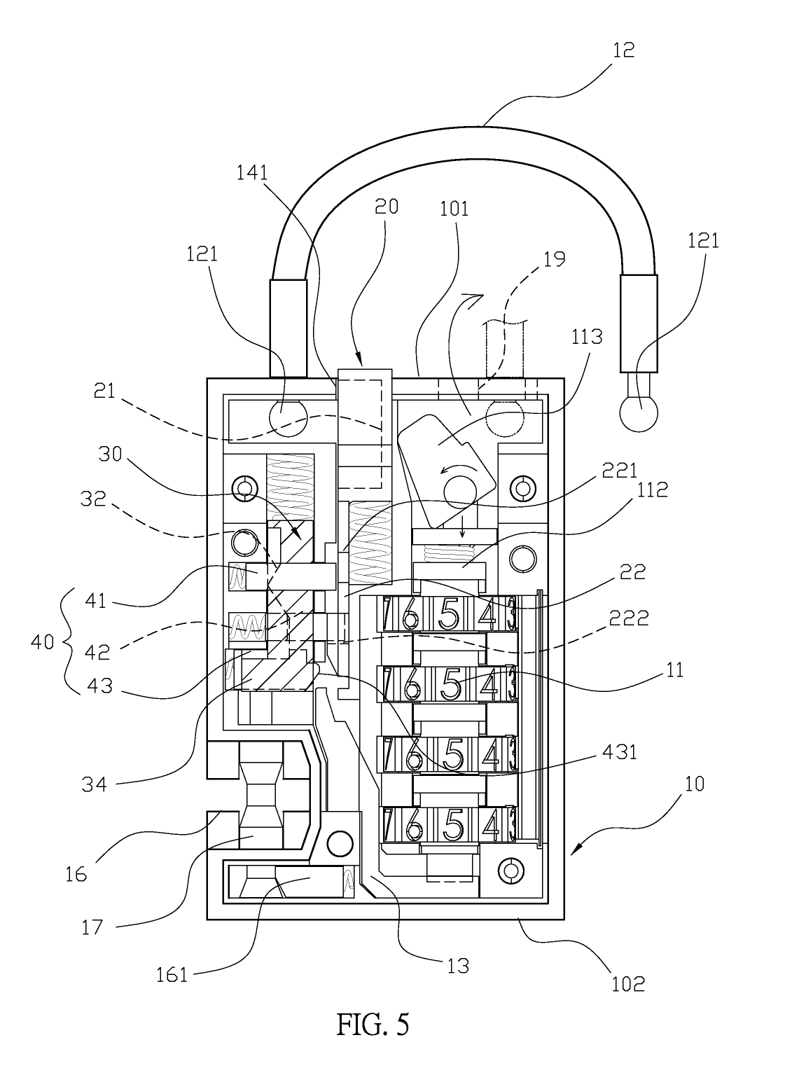

When in use, referring to FIGS. 2 to 5, the main objective of this invention is to provide a multi-functional lock, wherein the locking unit 12 uses the two balls 121 on two ends to disposed at the short groove 142 and aperture 19, and through the swing block 113 and the control unit 20, the unlocking process can be more effectively conducted. Furthermore, when the cipher lock 11 is unlocked, the locking rod 112 can move axially to enable the swing block to rotate to remove the blocking of the aperture 19, so one ball 121 of the locking unit 12 can be moved away from the aperture 19 to achieve the goal of unlocking on one end. Meanwhile, since the locking rod 112 can move axially, the conjugating unit 13 can be pushed by the user through the pressing hole 111 to restore the control unit 20.

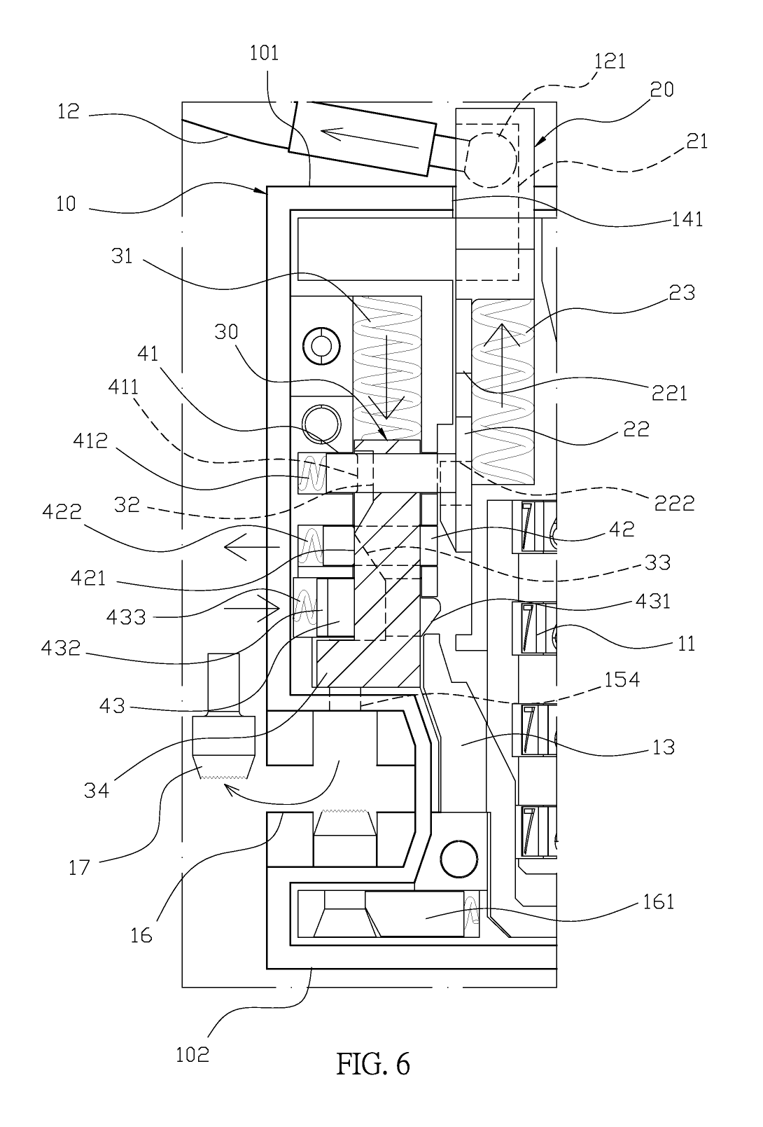

In another embodiment, referring to FIG. 6, when the user or officer wants to forcefully conduct the unlocking process, they can cut the rod 17 at the cut opening 16 of the main body 10 and half of the rod 17 close to the connecting unit 30 would detached, so the connecting unit 30 is pushed by the spring 31 toward the second position 102. Meanwhile, the protruding portion 421 of the second plug 42 is pushed by lower trough 33 to pull the second plug 42 out of the second notch 222 of the control unit 20, so the control unit 20 is pushed by the spring 23 to the first position 101 of the main body 10. At this time, the evading space 21 of the control unit 20 is protruding out from the through hole 141 and the ball 121 of the locking unit 12 can escape from the main body 10 through the evading space 21 to unlock the other end, so the user or officer can check something inside without unlocking the cipher lock 11. Also, when the connecting unit 30 is moving, the first plug 41 of the securing unit 40 does not block the protruding block 411 because of the movement of the upper trough 32 and the securing spring 412 can push the first plug 41 to contact the elongated board 22 of the control unit 20. Moreover, because the connecting unit 30 is moving towards the through opening 154, the stopping portion 432 of the restricting block 43 is not blocked by the stopping block 34 to push the restricting block 43 toward the control unit 20 through the spring 433, so the stopping portion 432 is blocking the upper portion of the stopping block 34 and the connecting unit 30 is restricted.

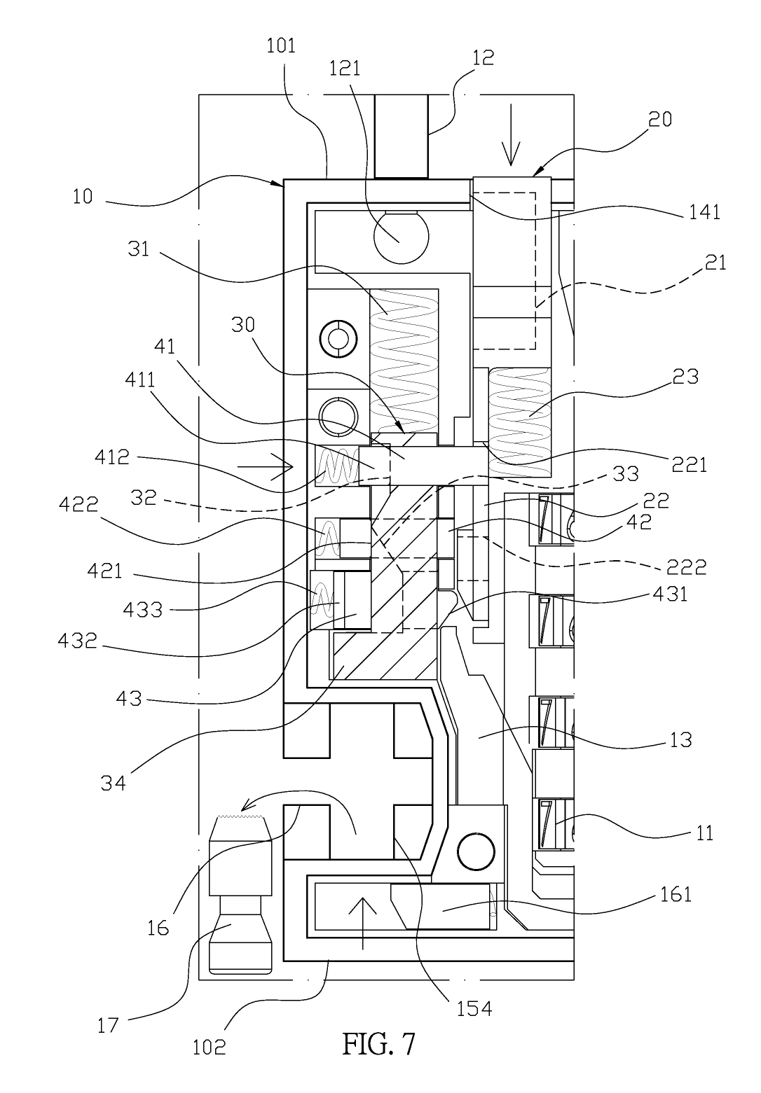

Referring to FIG. 7, when the main body 10 is locked, the user only needs to press the control unit 20 to enable the elongated board 22 of the control unit 20 to move toward the second position 102 of the main body 10. When the first notch 221 of the elongated board 22 is facing the first plug 41 of the securing unit 40, the first plug 41 will be pushed by the spring 412 to the first notch 221, so the evading space 221 of the control unit 20 is closed in the main body 10 to lock the locking unit 12 and cannot be opened. It is noted that the position of the control unit 20 is aligned with the surface of the main body 10 after being forcefully opened, so the user knows that the rod 17 may have to be replaced. When replacing the rod 17, the remaining portion can be pushed through the cut opening 16 via the through opening 154 and the remaining rod 17 will be removed from the fixed unit 161.

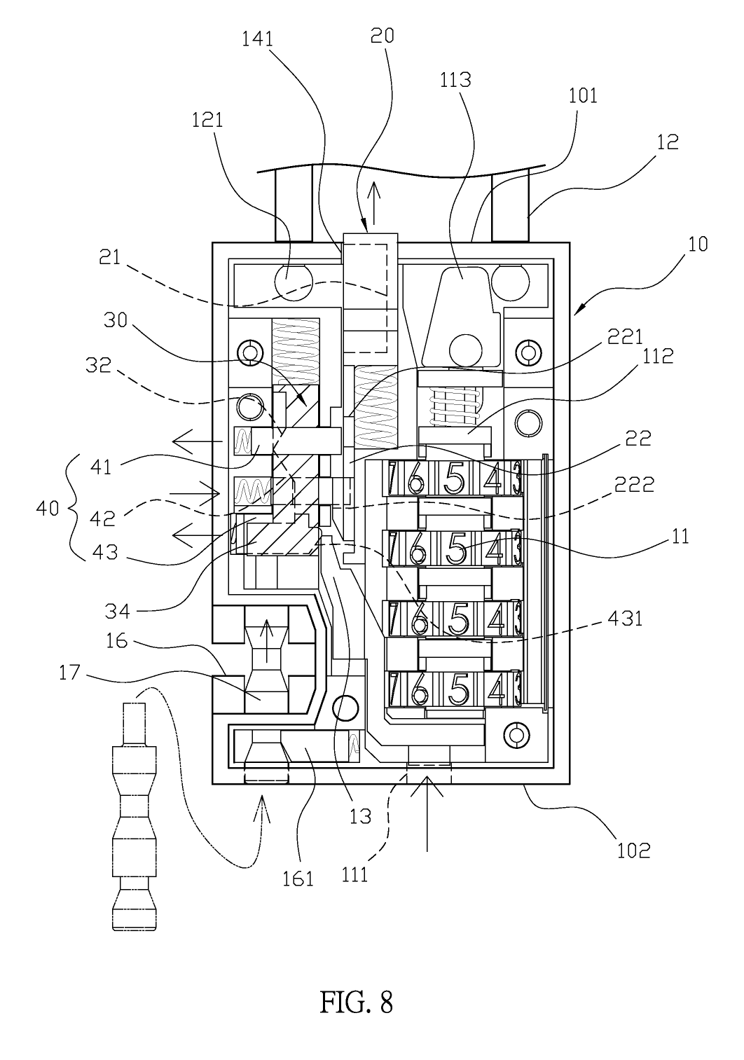

Referring to FIG. 8, when restoring to the original status, the user has to unlock the cipher lock 11 to push the conjugating unit 13 through the pressing hole 111, and the conjugating unit 13 is used to push the inclined surface 431 of the restricting block 43, so the stopping portion 432 of the restricting block 43 is not blocking the stopping block 34 of the connecting unit 30, and a new rod 17 can be plug into the through opening 154 and the connecting unit 30 is pushing the spring 31. At this time, the second plug 42 of the securing unit 40 is pushed by the spring 422 toward the elongated board 22 due to the movement of the lower trough 33 of the connecting unit 30, and the first plug 41 will be pulled out from the first notch 221 due to the movement of the upper trough 32 of the connecting unit 30, so the control unit 20 slightly moves toward the main body 10 and the second plug 42 is plugged into the second notch 222 to form a secured position because the control unit 20 is slightly protruding from the main body 10.

According to the abovementioned embodiments, the present invention is advantageous because (1) the main body 10 uses the connecting unit 30 to control the securing unit 40 and control unit 20, and the rod 17 and the locking unit 12 are independent components, so when the user is conducting a forcefully unlocking process, only the rod 17 is damaged without damaging the main body 10 and the rod 17 can be easily replaced; (2) the locking unit 12 is placed inside of the main body 10 through hole 141 and aperture 19 with the ball 121. Also, the ball 121 is restricted by a short groove 142 and aperture 19 to lock the main body 10, and user can unlock from either the cipher lock 11 or the control unit 20.

Having described the invention by the description and illustrations above, it should be understood that these are exemplary of the invention and are not to be considered as limiting. Accordingly, the invention is not to be considered as limited by the foregoing description, but includes any equivalents.

1. A multi-functional lock comprising:
a main body, having a first position and a second position, one side of the main body having a cipher lock that has a locking unit at the first position, and a pressing hole is located at the second position; a conjugating unit located between the pressing hole and the cipher lock; a receiving space formed on the other side of the cipher lock and having a through hole communicating with the first position; one side of the receiving space having a vertical trough, and a first horizontal trough, a second horizontal trough and a third horizontal trough formed between the vertical trough and the receiving space, and the third horizontal trough closest to the conjugating unit; the vertical trough having a through opening communicating with the second position and a cut opening formed at the through opening, and a covering board used to cover the main body;
a control unit located at the receiving space of the main body and having an evading space near the through hole; an elongated board located at one end of the control unit and the elongated board having a first notch and a second notch, and a spring located at one side of the elongated board;
a connecting unit located at the vertical trough of the main body, and a connecting spring disposed at one end of the rod, wherein the connecting unit has an upper trough, a lower trough and a stopping block, and the upper trough and the lower trough are formed along an opposite direction and the upper trough, lower trough and stopping block are located at back side of the control unit; and
a securing unit having a first latch, a second latch and a restricting block; the first latch disposed inside the first horizontal trough and having a protruding block corresponding to the upper trough; and a securing spring disposed on top of the protruding block; a protruding piece corresponding to the lower trough disposed at the second horizontal trough, and a spring disposed at a top portion of the protruding piece; an inclined surface is formed on one end of the conjugating unit, a stopping portion protrudingly formed on the other end of the restricting block, and a second spring disposed at the same end of the stopping portion,
wherein the cipher lock has a locking rod connecting with a swing block close to the locking unit, and a receiving space is formed on the other side of the cipher lock and has a through hole communicating with the first position, wherein the locking unit is a long and elastic rod and a ball is formed on each of both ends of the locking unit, and the ball is inserted into the main body through the aperture and the through hole, and
wherein the locking rod is configured move axially to enable the swing block to rotate to remove the blocking of the aperture, so the ball at each end of the locking unit move away from the aperture to unlock the locking unit.

2. (canceled)

3. The multi-functional lock of claim 1, wherein a fixed unit is formed close to the second position and the fixed unit is disposed against the rod due to a resilience force of the fixed unit to control the rod.
